(19) United States
(12) Patent Application Publication
(10) Pub. No.: US 2024/0403133 A1
(43) Pub. Date: Dec. 5, 2024

(54) METHODS AND APPARATUS TO IMPROVE CODE UNDERSTANDABILITY FOR CLOUD RESOURCE MANAGEMENT

(71) Applicant: VMware LLC, Palo Alto, CA (US)

(72) Inventors: RAJAN DILIP INGLE, Pune (IN); Krishna Omprakash Dayma, Pune (IN); Alka Rauthan, Bangalore (IN); Sagar Sheetalchandra Hukkeri, Pune (IN); Tanmay Ajit Gujar, Pune (IN)

(21) Appl. No.: 18/227,999

(22) Filed: Jul. 31, 2023

(30) Foreign Application Priority Data
May 29, 2023 (IN) 202341036979

(51) Int. Cl. G06F 9/50

(52) U.S. Cl. CPC G06F 9/5077; G06F 9/5072

(57) ABSTRACT

Systems, apparatus, articles of manufacture, and methods are disclosed. An example apparatus includes at least one memory; programmable circuitry; and instructions to cause the programmable circuitry to: identify configurable parameters in an infrastructure configuration file, the configurable parameters to define states of a cloud resource; map a first configurable parameter of the configurable parameters to a first state of the states based on first metadata parsed form the infrastructure configuration file, the first state displayed in a graphical user interface including a hierarchy of states, wherein selection of a second state of the plurality of states from the hierarchy displays a second configurable parameter associated with the second state; and prevent a misconfiguration of the cloud resource based on an application of a validation constraint to an input value for the second configurable parameter, the validation constraint generated based on second metadata parsed from the infrastructure configuration file.

### RELATED APPLICATIONS

Benefit is claimed under 35 U.S.C. 119(a)-(d) to Foreign Application Serial No. 202341036979 filed in India entitled “METHODS AND APPARATUS TO IMPROVE CODE UNDERSTANDABILITY FOR CLOUD RESOURCE MANAGEMENT”, on May 29, 2023, by VMware, Inc., which is herein incorporated in its entirety by reference for all purposes.

### FIELD OF THE DISCLOSURE

This disclosure relates generally to management of cloud resources and, more particularly, to methods and apparatus to improve code understandability for cloud resource management.

### BACKGROUND

Cloud computing is the delivery of computing resources including storage, processing power, databases, networking, analytics, artificial intelligence, and software applications via a networked data center. Cloud servers may include compute, memory, and/or storage resources to remotely perform services and functions for an organization.

### BRIEF DESCRIPTION OF THE DRAWINGS

FIG. 1 is a schematic block diagram of an example environment in which an example code management circuitry can be implemented.

FIG. 2 is a block diagram of an example implementation of the code management circuitry of FIG. 1.

FIG. 3 is an illustration of an example user interface to improve code understandability for cloud resource management.

FIG. 4A is an illustration of an example input and code editor area to improve code understandability for cloud resource management.

FIG. 4B is an illustration of an example state area to improve code understandability for cloud resource management.

FIG. 5A is an illustration of an example user with an input button selected.

FIG. 5B is an illustration of another example input area for code understandability.

FIG. 5C is an illustration of how tooltips and a validation buttons can improve code understandability for cloud resource management.

FIG. 6 is a flowchart representative of example machine readable instructions and/or example operations 600 that may be executed, instantiated, and/or performed by programmable circuitry to improve code understandability.

FIG. 7A is a flowchart representative of example machine readable instructions and/or example operations 700 that may be executed, instantiated, and/or performed by programmable circuitry to implement the code management circuitry 122 of FIG. 1.

FIG. 7B is a flowchart representative of example machine readable instructions and/or example operations 710 that may be executed, instantiated, and/or performed by programmable circuitry to display configurable parameters associated with states.

FIG. 8 is a flowchart representative of example machine readable instructions and/or example operations that may be executed, instantiated, and/or performed by example programmable circuitry to display states of a cloud resource and associated configurable parameters.

FIG. 9 is a block diagram of an example processing platform including programmable circuitry structured to execute, instantiate, and/or perform the example machine readable instructions and/or perform the example operations of FIGS. 6-8 to implement the code management circuitry 122 of FIG. 2.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 6-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

In recent years, increasingly large and complex computational workloads (e.g., artificial intelligence, cryptography, scientific simulations, etc.) have been deployed to cloud servers. Such workloads may be associated with a large numbers of virtual machines, containers, and/or other cloud resources, which may be spread across multiple cloud providers. In a virtual infrastructure, such as a multi-cloud management platform, a cloud endpoint is a system and/or a service on which a user can provision resources. The cloud endpoint may be a public cloud resource (e.g., a web service such as Amazon Web Services (AWS)™, etc.), a virtual appliance (e.g., an external orchestrator appliance, etc.), a private cloud (e.g., hosted by VMware vSphere™, Microsoft Hyper-V™, etc.), etc. A service may have multiple cloud endpoints, such as a catalog service that provides catalog features for a shell/user interface application service to consume. Cloud endpoints may include physical endpoints, virtual endpoints, Internet Protocol Address Management (IPAM) endpoints, etc.

Virtualization technologies can be used for computing, storage, and/or networking. Using virtualization, hardware computing resources and/or other physical resources can be replicated in software. One or more application programming interfaces (APIs) can be implemented to provide access to virtualized resources for users, applications, and/or systems while limiting or masking underlying software and/or hardware structures. Virtualization is increasingly executed in the cloud environment.

Cloud environments can be complex, with a large number of resources to be managed and configured. This can make it difficult for organizations to ensure that their cloud resources are configured correctly and for optimized performance. Cloud management services (e.g., VMware VRealize Automation™, VMware Aria Automation™, etc.) allow a user to create and/or otherwise deploy machines, applications, and/or services to a cloud infrastructure. Such cloud management services may include a blueprint development and deployment service. A deployment in a cloud-based service is a provisioned instance of a blueprint. As used herein, blueprints are specifications that define machines, applications, and/or services that can be deployed to cloud resources. Blueprints may be developed to target specific cloud vendors and/or resources (e.g., Amazon Web Services (AWS)™, a virtual appliance such as an external orchestrator appliance, etc., VMware vSphere™, Microsoft Hyper-V™, etc.).

IDEM, short for “Infrastructure Deployment and Execution Manager,” is a tool developed by VMware® that can streamline the deployment and management of cloud resources based on a paradigm called infrastructure as code (IaC). IaC allows organizations to automate provisioning and/or configuration of one or more cloud resources that may be distributed across one or more cloud resource providers. IaC also makes it easier to maintain and update cloud infrastructure over time, scale cloud infrastructure up or down as needed, and efficiently respond to changing business needs.

When a blueprint is deployed, a cloud management service (e.g., vRealize Automation™) may use a set of rules and policies to automatically provision and configure resources to create the desired virtual environment. This can include deploying virtual machines from templates, creating networks and storage, and configuring various software components and settings. By using blueprints, organizations can ensure consistency and repeatability in their virtualized environments, while also reducing the amount of effort required for deployment and maintenance of the virtualized environment. Additionally, blueprints can be versioned and shared across teams, making it easier to collaborate and streamline the development and deployment process.

Infrastructure as data (IaD) further simplifies the blueprint deployment process, expanding upon the IaC concept and reducing cloud configuration to data. IaD is a declarative approach to deployment and management of cloud infrastructure. Techniques described herein are interoperable with both IaD and IaC paradigms.

With IaC, a user can describe a desired state (e.g., in a salt state system (SLS file)) without specifying precise actions or steps for how to achieve the state. Then, cloud provisioning circuitry can deploy and/or modify the cloud infrastructure to achieve the described state.

As described herein, a SLS file (e.g., a .sls file) is a file written in the YAML ain't markup language (YAML) format. The SLS file may contain data and/or instructions for management and configuration of cloud infrastructure, such as that provided by a cloud resource provider through use of an infrastructure configuration file (e.g., an IDEM doc file, a SLS file, a JSON file, etc.) instead of a script. This can simplify deployment and maintenance of cloud infrastructure.

However, effectively using an infrastructure configuration file (e.g., IDEM, XML, etc.) to write configuration files presents multiple challenges. First, the infrastructure configuration file syntax has many complexities that demand significant domain expertise. Furthermore, when a user deploys code (e.g., IDEM code), there may be no validation in place to notify the user of any required parameters. Furthermore, conventional systems lack intelligent suggestions for parameters, provide limited support for different data types (e.g., only accepting strings as inputs), provide unclear representation of states, lack state-wise code segregation, and lack state-wise parameter validation.

Disclosed examples include a client-side framework to parse (e.g., traverse) an infrastructure configuration (an IDEM SLS) file. Some examples use metadata identified in the infrastructure configuration (e.g., SLS) file to improve IDEM code. Examples disclosed herein enable state-wise code segregation, provide clear representations of states, support state-wise parameter validation, and improve understandability of IaD files.

By extracting data from an infrastructure configuration file and presenting the data to the user in an understandable graphical user interface, even a user without domain expertise can manage an IaD file. In some examples, a user can mark states as complete or incomplete before deployment to avoid errors during deployment. Thus, disclosed examples allow users to focus on the parameters required for an infrastructure configuration file or a cloud template, without having to understand details of its syntax.

Disclosed examples are described in association with SLS files. However, examples disclosed herein can interoperate with any type of infrastructure as code file. Examples include JavaScript Object Notation (JSON) files, extensible Markup Language (XML) files, comma-separated value (CSV) files, etc. In general, any a markup language or programming language that that defines rules for encoding infrastructure management data can be used with examples disclosed herein.

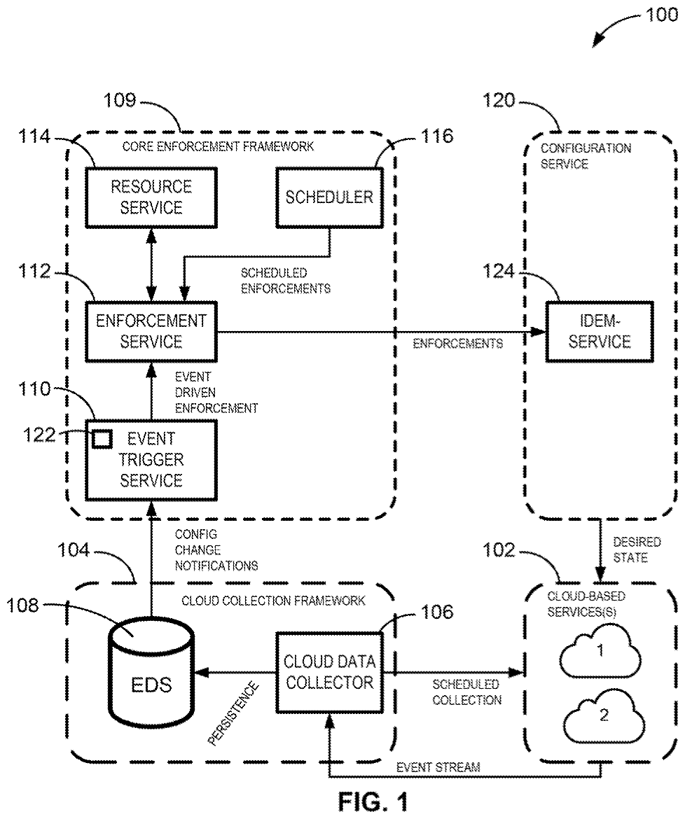

Turning to the figures, FIG. 1 is a schematic block diagram of an example environment 100 in which an example code management circuitry 122 operates to improve code understandability for cloud resource management. In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1 is only an example and any appropriate other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 can extract, receive and/or query information (e.g., components, metadata, services, service information) from the cloud-based service(s) 102. In this example, the cloud data collector 106 can request and/or direct the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110 that implements the aforementioned code management circuitry 122, an example enforcement service 112, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service 124 that is distinct from the core enforcement framework 109 and, thus, the enforcement service 112. However, the IDEM service 124 can be integrated with the enforcement service 112 and/or the core enforcement framework 109 in other examples. In the illustrated example of FIG. 1, the IDEM service 124 is an implementation/provisioning engine that implements desired state changes with respect to the cloud-based service(s) 102. In other words, the IDEM service 124 controls a desired state of the cloud service(s) 124 based on enforcements provided from the enforcement service 112. While the code management circuitry 122 is shown implemented in the example event trigger service 110, additionally or alternatively, the code management circuitry 122 can be implemented in the enforcement service 112, the resource service 114 and/or the scheduler 116.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services, examples disclosed herein can be implemented in conjunction with any appropriate distributed and/or shared computing resource system.

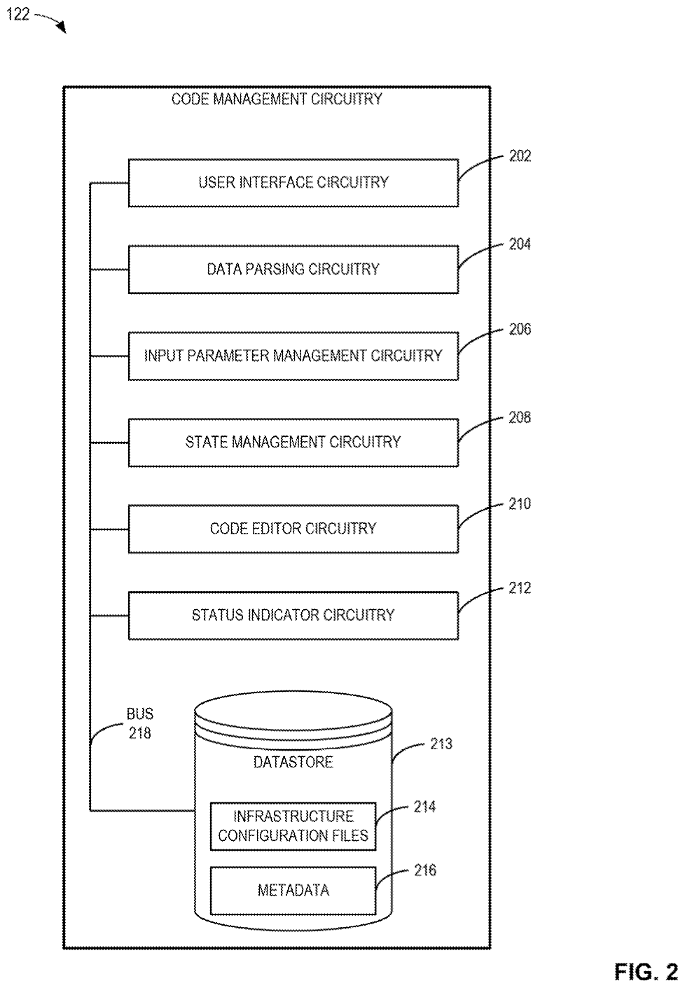

FIG. 2 is a block diagram of an example implementation of the code management circuitry 122 of FIG. 1 to improve code understandability for cloud resource management. The code management circuitry 122 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the code management circuitry 122 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

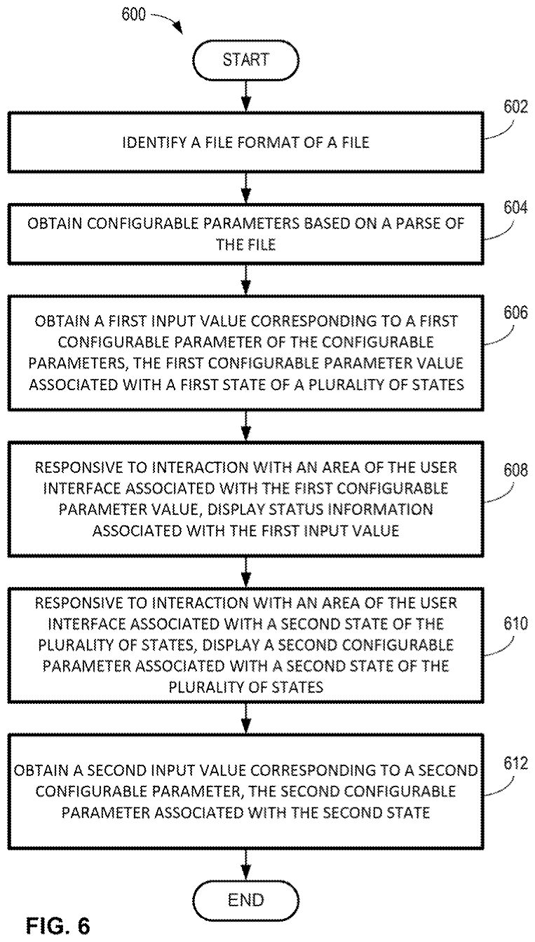

The example code management circuitry 122 includes example user interface circuitry 202, example data parsing circuitry 204, example input parameter management circuitry 206, example state management circuitry 208, example code editor circuitry 210, example status indicator circuitry 212, example infrastructure configuration files 214, example metadata 216, and an example bus 218. In some examples, the code management circuitry 122 is instantiated by programmable circuitry executing code management circuitry instructions and/or configured to perform operations such as those represented by the flowchart(s) of FIGS. 6-8.

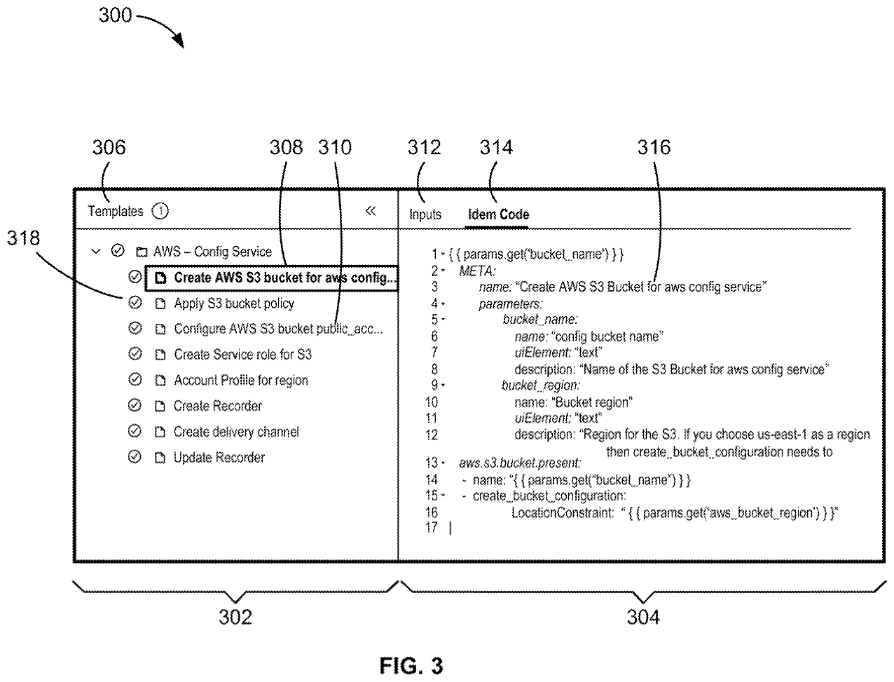

The example code management circuitry 122 includes the example user interface circuitry 202. The user interface circuitry 202 provides an interface for a user to input parameters, with validation, suggestions, and data types. Accordingly, the user interface circuitry 202 can reduce the potential for errors and improve code quality. In general, the user interface circuitry 202 displays code (e.g., IDEM code) in an organized fashion, allowing for better management and maintenance of the code. The structure and function of the user interface circuitry 202 will be described in detail in association with FIGS. 3-5C. In particular, the user interface circuitry 202 includes at least three distinct areas: 1) a states area (e.g., an area to display states in a hierarchical format); 2) an input parameter area (e.g., an area to receive input parameters; and 3) a code editor area (e.g., to allow for viewing and editing of infrastructure configuration files).

In some examples, the user interface circuitry 202 provides interface elements to manage infrastructure configuration files. For example, the user interface circuitry 202 may include a text editor in the code editor area for editing and/or management of an IaC file. In some examples, the user interface circuitry 202 may include a rich text editor that offers additional capabilities for a more comprehensive input offering. For example, the user interface circuitry 202 may provide tooltips to provide a user suggestions for improved code understandability.

The user interface circuitry 202 can display a window (e.g., in the code editor area) with raw code, which allows editing code directly. The user interface circuitry 202 may also provide a state-wise tree structure (e.g., displayed in the state area) that facilitates navigation and editing of the code. The user interface circuitry 202 simplifies the editing process, streamlines IaC editing and management through effective presentation of data.

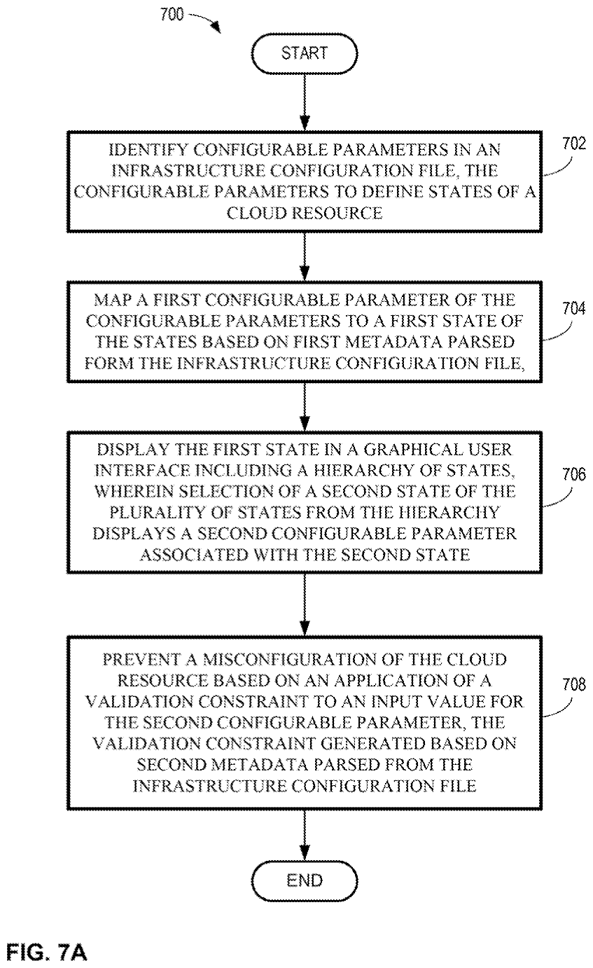

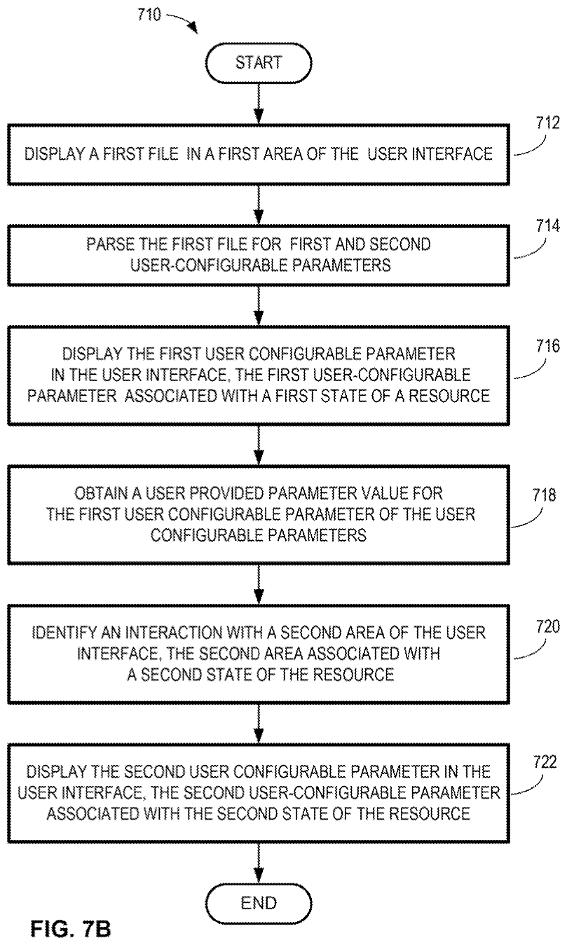

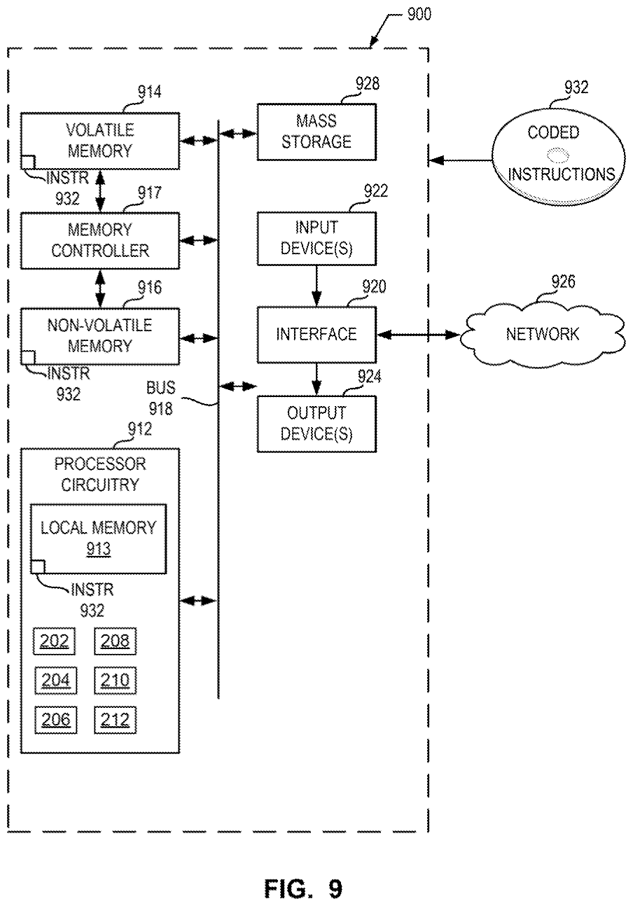

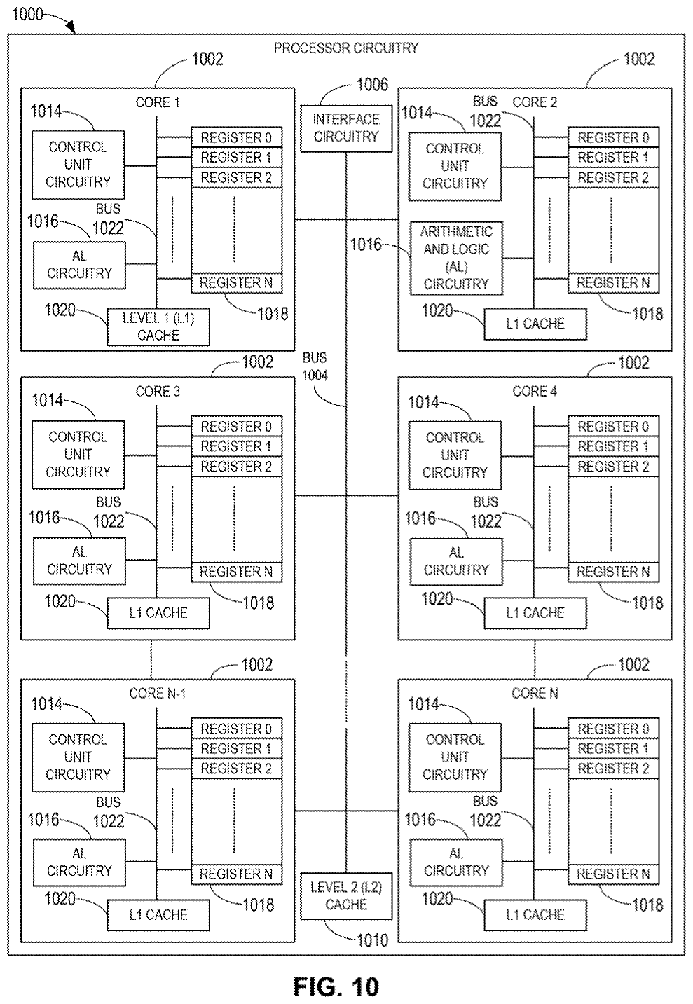

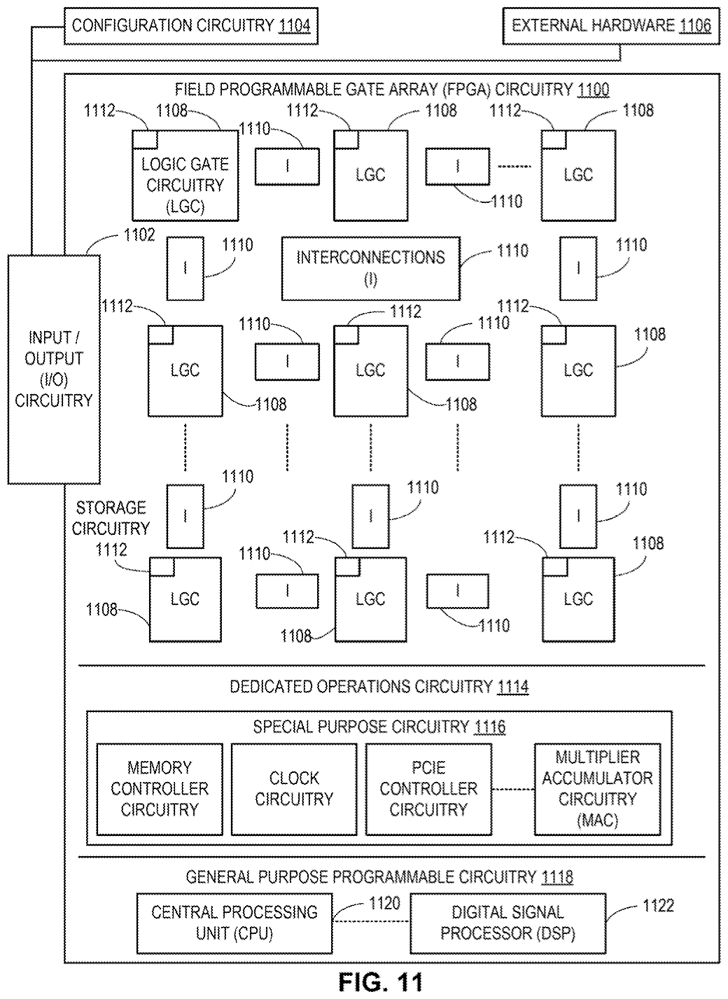

In some examples, the code management circuitry 122 includes means for generating a user interface with three areas. For example, the means for generating may be implemented by user interface circuitry 202. In some examples, the user interface circuitry 202 may be instantiated by programmable circuitry such as the example programmable circuitry 912 of FIG. 9. For instance, the user interface circuitry 202 may be instantiated by the example microprocessor 1000 of FIG. 10 executing machine executable instructions such as those implemented by at least blocks 704, 706 of FIG. 7. In some examples, the user interface circuitry 202 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the user interface circuitry 202 may be instantiated by any other combination of hardware, software, and/or firmware. For example, the user interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example code management circuitry 122 includes data parsing circuitry 204. In some examples, the data parsing circuitry 204 may parse an infrastructure configuration file using metadata that is a part of the infrastructure configuration file (e.g., in an SLS file). The example data parsing circuitry 204 may identify metadata that labels the input parameters. For example, a data type field for an input can be set in the metadata (e.g., an SLS file meta) and will be rendered accordingly, providing a user with context of the input parameter.

In some examples, metadata is structured as a key-value pair associated with the parameters. The key can represent a specific parameter name or identifier, while the corresponding value contains additional information about the parameter, such as its purpose, data type, allowed values, etc. In general, the metadata may be used by the code management circuitry 122 to generate a user interface that presents, to a user, information about the parameter including an expected format and behavior of the parameter. In some examples, the data parsing circuitry 204 provides information about a parameter to the input parameter management circuitry 206. In some examples, the data parsing circuitry 204 can use metadata to identify parameters within an SLS file and any dependencies or relationships between parameters in the SLS file. In this way, a user can identify, understand, and work with the parameters present in the file.

In some examples, the data parsing circuitry 204 can identify configurable parameters in an infrastructure configuration file, the configurable parameters to define states of a cloud resource. For example, the data parsing circuitry 204 can identify a tag of an infrastructure configuration file (e.g., a meta tag, a start tag, an end tag, other markup elements, etc.). In some examples, the infrastructure configuration file is a text encoded file (e.g., YAML, XML, etc.) and the configurable parameters include parameters to modify settings (e.g., security settings, performance settings, and cost) of a cloud resource.

In some examples, the code management circuitry 122 includes means for parsing an infrastructure configuration file. For example, the means for parsing may be implemented by data parsing circuitry 204. In some examples, the data parsing circuitry 204 may be instantiated by programmable circuitry such as the example programmable circuitry 912 of FIG. 9. For instance, the data parsing circuitry 204 may be instantiated by the example microprocessor 1000 of FIG. 10 executing machine executable instructions such as those implemented by at least block 714 of FIG. 7. In some examples data parsing circuitry 204 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the data parsing circuitry 204 may be instantiated by any other combination of hardware, software, and/or firmware. For example, data parsing circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example code management circuitry 122 includes input parameter management circuitry 206. In some examples, the input parameter management circuitry 206 accepts and manages the following data types for input parameters: text, number, email, select, multiselect, radio, boolean, text area, array, object, JSON, infrastructure region, etc.

The input parameter management circuitry 206 may include various graphical user interface elements such as dropdown menus to provide a predefined list of options for users to choose from. Such an element may be used when there are a limited number of possible parameter values. For example, there may be a parameter with a limited number of available values, and rather than a user entering a parameter manually, the user interface circuitry 202 may provide a predetermined number of available parameters. This reduces the chances of input errors. Similarly, checkboxes, radio buttons, and sliders provide a visual way to input numeric values within a specified range.

In some examples, the input parameter management circuitry 206 provides contextual help and documentation accessible through tooltips, inline hints, or dedicated help panels. Tooltips can provide guidance to users to reduce errors caused by users inputting incorrect data.

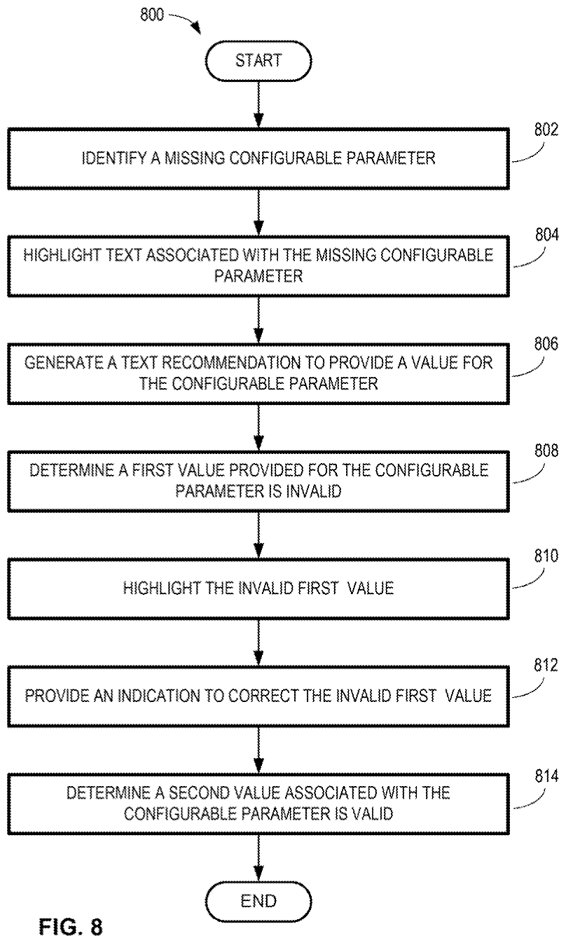

Put In some examples, the code management circuitry 122 includes means for managing input parameters. For example, the means for managing input parameters may be implemented by input parameter management circuitry 206. In some examples, the input parameter management circuitry 206 may be instantiated by programmable circuitry such as the example programmable circuitry 912 of FIG. 9. For instance, the input parameter management circuitry 206 may be instantiated by the example microprocessor 1000 of FIG. 10 executing machine executable instructions such as those implemented by at least blocks 812 of FIG. 8. In some examples, the input parameter management circuitry 206 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the input parameter management circuitry 206 may be instantiated by any other combination of hardware, software, and/or firmware. For example, the input parameter management circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example code management circuitry 122 includes state management circuitry 208. The state management circuitry 208 provides a representation of states in a tree structure, giving the user the ability to select a state and configure the state (e.g., by changing input values) independently of other states. This allows for improved organization and management of the code.

In examples disclosed herein, a state refers to a configuration of cloud resources. For example, a state can provide information about infrastructure components of cloud resources and provisioning of the cloud resources. Thus, the state management circuitry 208 may provide information including characteristics of the cloud resource (e.g., storage size, network configurations, access controls, software versions, etc.). States that a cloud resource and/or infrastructure can be a provisioning state to provision the cloud resource, a scaling state to scale the cloud resource, and a modification state to modify the cloud resource. Specific states may be associated with corresponding configurable parameters. For example, a provisioning state may be associated with configurable parameters to provision a resource at a first cloud resource (e.g., CPU selection, storage selection, network throughput selection, etc.). A scaling state may include configurable parameters to dynamically scale up or scale down the cloud resources. A modification state can include input parameters to change characteristics of the cloud resource that were selected in the provisioning state. The modification state may include configurable parameters to change a type of server (e.g., change from micro to large), modify a characteristic of the cloud resource (e.g., a server location), etc. Provisioning, scaling, and mapping states are only illustrative states, and any state that a cloud resource is in may be displayed by the state management circuitry 208.

The state management circuitry 208 can receive data parsed by the data parsing circuitry 204 from infrastructure configuration data file (e.g., an IDEM file, based on metadata associated with the IDEM data file, etc.) in a state-wise manner. That is, the state management circuitry 208 and/or the input parameter management circuitry 206 can identify parameters of an IDEM data file and associate the parameters with one or more states. Then, when a user interacts with the input parameter management circuitry 206, the user can select a state to view parameters associated with the state. By parsing the infrastructure data file in a state wise manner (e.g., based on using metadata parameters associated with a state and/or a parameter), the state management circuitry 208 can map a first configurable parameter of the configurable parameters to a first state of the states based on first metadata parsed from the infrastructure configuration file. In some examples, the first state can be displayed in a graphical user interface including a hierarchy of states. Then, when a user selects a second state of the plurality of states from the hierarchy, second configurable parameters associated with the second state can be displayed.

In some examples, the code management circuitry 122 includes means for managing states of a cloud infrastructure. For example, the means for managing may be implemented by state management circuitry 208. In some examples, the state management circuitry 208 may be instantiated by programmable circuitry such as the example programmable circuitry 912 of FIG. 9. For instance, the state management circuitry 208 may be instantiated by the example microprocessor 1000 of FIG. 10 executing machine executable instructions such as those implemented by at least blocks 716 of FIG. 7. In some examples, state management circuitry 208 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the state management circuitry 208 may be instantiated by any other combination of hardware, software, and/or firmware. For example, the state management circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example code management circuitry 122 includes example code editor circuitry 210. The code editor circuitry 210 can display a code editor for a user to modify an infrastructure configuration file (e.g., an SLS file) directly. Thus, users that desire a heightened level of customization over the state of their cloud resource can edit an infrastructure data file directly. On the other hand, users that are not familiar with the intricacies of the infrastructure data file can interact with the input parameter management circuitry 206, which may provide a simplified user interface for management of parameters. As will be described below in association with FIGS. 3-5C, examples disclosed herein allow a user to easily switch from a code view to an input view.

The code editor circuitry 210 may include features such as syntax highlighting, auto-completion, code formatting, line numbering, error checking, etc. As the code management circuitry 122 includes both the input parameter management circuitry 206 and the code editor circuitry 210, the code management circuitry 122 can allow a wide range of users to effectively edit code. Less technical users can perform cloud resource management without having to understand the complexities of an infrastructure configuration file. Yet, the user interface 300 also allows more technical users to leverage the full flexibility and power of their selected infrastructure configuration file (e.g., IDEM) by editing code directly in the second area 304 after selecting a code editor button 314.

In some examples, the code management circuitry 122 includes means editing infrastructure as code files. For example, the means for editing may be implemented by code editor circuitry 210. In some examples, the code editor circuitry 210 may be instantiated by programmable circuitry such as the example programmable circuitry 912 of FIG. 9. For instance, the code editor circuitry 210 may be instantiated by the example microprocessor 1000 of FIG. 10 executing machine executable instructions such as those implemented by at least blocks 708 of FIG. 7. In some examples, the code editor circuitry 210 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the code editor circuitry 210 may be instantiated by any other combination of hardware, software, and/or firmware. For example, the code editor circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example code management circuitry 122 includes example status indicator circuitry 212. The status indicator circuitry 212 can provide additional details about parameters that were identified by the data parsing circuitry 204 and displayed by the user interface circuitry 202. For example, the status indicator circuitry 212 can provide types that are acceptable for a configurable parameter (e.g., valid input values), default settings for the input parameter, etc.

The status indicator circuitry 212 may also present error messages when a parameter is invalid. The status indicator circuitry 212 can also provide an indicator that a required parameter is missing an input value. Status indicators can be associated with one or more configurable parameters, helping users identify errors before a cloud infrastructure is deployed. In some examples, the status indicator circuitry 212 can present suggestions to guide a user to a valid input. For example, a user may input a boolean value for a configurable parameter that only accepts strings. In such a scenario, the status indicator circuitry 212 can provide an indicator that an incorrect data type has been entered. Similarly, a user may attempt to validate and deploy a cloud resource configuration without having provided input values to all required configurable parameters. Then, the status indicator circuitry 212 can provide a status indicator that prompts the user to input a value for the required parameter.

In some examples, the status indicator circuitry 212 can, provide responsive to interaction with an area of the graphical user interface associated with the first configurable parameter, display status information associated with the first configurable parameter. For example, the status information may include an indicator that the first configurable parameter is missing, invalid, required, etc. In some examples, the status indicator may be viewable via a tooltip that presents information to a user when it is hovered over, clicked, and/or otherwise interacted with. The status information may be displayed via a graphical user interface. In some examples, the status information may be displayed based on

The example status indicator circuitry 212 can also prevent a misconfiguration of the cloud resource based on an application of a validation constraint to an input value for the second configurable parameter. For example, the input parameter management circuitry 206 and/or the state management circuitry 208 can generate a validation constraint based on metadata obtained from an infrastructure configuration file. The validation constraint can also be generated based on a user input, a programmatic input, etc. Then, the status indicator circuitry 212 can determine if the validation constraint is satisfied and provide an according tooltip indicator. In some examples, the validation constraint is used in preventing misconfiguration of the cloud resource. For example, a type of an input parameter may be incompatible with a type of an associated configurable parameter. In such a scenario, the—code management circuitry 122 would identify that the input value has failing to satisfy a validation constraint and would prevent the deployment of the cloud resource until the validation constraint is satisfied.

In some examples, the code management circuitry 122 includes means for providing a status indicator. For example, the means for providing may be implemented by status indicator circuitry 212. In some examples, the status indicator circuitry 212 may be instantiated by programmable circuitry such as the example programmable circuitry 912 of FIG. 9. For instance, the status indicator circuitry 212 may be instantiated by the example microprocessor 1000 of FIG. 10 executing machine executable instructions such as those implemented by at least blocks 806 of FIG. 8. In some examples, status indicator circuitry 212 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the status indicator circuitry 212 may be instantiated by any other combination of hardware, software, and/or firmware. For example, the status indicator circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example code management circuitry 122 further includes the datastore 213. In this example, the datastore 213 includes infrastructure data files 214 and metadata 216. The infrastructure data files 214 may be a SLS file or any type of infrastructure as data and/or infrastructure as code file. Metadata 216 may be stored as part of the infrastructure data files 214. In other examples, the metadata. The bus 218 provides communication between the user interface circuitry 202, the data parsing circuitry 204, the input parameter management circuitry 206, the state management circuitry 208, the code editor circuitry 210, and the status indicator circuitry 212. The code management circuitry 122 may also be connected to a network such as the Internet.

While an example manner of implementing the code management circuitry 122 of FIG. 1 is illustrated in FIG. 2, one or more of the elements, processes, and/or devices illustrated in FIG. 2 may be combined, divided, re-arranged, omitted, eliminated, and/or implemented in any other way. Further, the user interface circuitry 202, the data parsing circuitry 204, the input parameter management circuitry 206, the state management circuitry 208, the code editor circuitry 210, and the status indicator circuitry 212, and/or, more generally, the example code management circuitry 122 of FIG. 2, may be implemented by hardware alone or by hardware in combination with software and/or firmware. Thus, for example, any of the user interface circuitry 202, the data parsing circuitry 204, the input parameter management circuitry 206, the state management circuitry 208, the code editor circuitry 210, and the status indicator circuitry 212, and/or, more generally, the example code management circuitry 122, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example code management circuitry 122 of FIG. 2 may include one or more elements, processes, and/or devices in addition to, or instead of, those illustrated in FIG. 2, and/or may include more than one of any or all of the illustrated elements, processes and devices.

FIG. 3 is an illustration of a graphical user interface 300 to improve understandability of infrastructure as code. The graphical user interface 300 includes a first area 302, a second area 304, a template button 306, a first state 308, a second state 310, an input button 312, a code editor button 314, and infrastructure configuration file 316.

The example user interface circuitry 202 of the code management circuitry 122 can instantiate the graphical user interface 300. The graphical user interface 300 provides a framework with two areas: the first area 302 and the second area 304. In the interface 300, the second area 304 includes both an input area and a code editor area that can be selected based on the input button 312 and the code editor button 314. However, in other examples there may be three distinct areas displayed on the graphical user interface 300.

The first area 302 generally provides an area for a user to select templates. A template can include both states and code, specifying what and how infrastructure resources are deployed across private, hybrid and public clouds. Templates may also define dependencies between the resources. In other words, a cloud resource template is a file that defines characteristics of a cloud infrastructure. Templates are an example of IaC, allowing deployment of infrastructure without the need to write and execute sequences of programming commands to deploy the infrastructure. In a cloud template, the user specifies a resource to deploy and properties for the resource. For example, a cloud template may be a JSON file that defines what infrastructure will be used for deployment, configuration, and maintenance of the cloud resource. For example, by selecting an input button 312 of the second area 304, a site reliability engineer (SRE) does not have to interpret the code of the infrastructure configuration file 316 and can focus on the parameters required for the infrastructure configuration file.

The template button 306 may allow a user to select from templates that define compliance for multiple different states of a deployment (e.g., bootstrap, security, configuration, cost, etc.). The first area 302 also provides a plurality of states including a first state 308 and a second state 310.

The code management circuitry 122 allows users to mark states as complete or incomplete before proceeding with deployment of a cloud resource. This is seen in the complete status indicator 318. In some examples, when a state is incomplete, there is no complete status indicator. In some examples, when a state is incomplete, an incomplete status indicator is placed next to the incomplete state. This allows a user to easily identify that any and all relevant steps are completed before deployment, thereby reducing the risk of errors and failures during the deployment process. In other words, by marking states as complete or incomplete, users can easily keep track of their progress and ensure that they have completed all necessary steps before proceeding. This feature also serves as a pre-check before deployment, ensuring that all required information and parameters have been entered correctly and minimizing the risk of deployment errors.

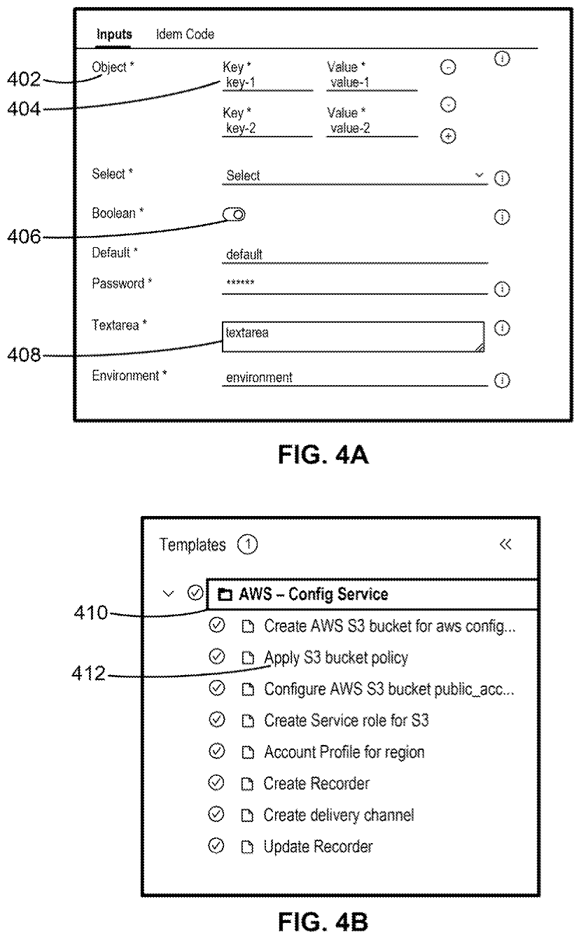

FIG. 4A is an illustration of an example input area to improve code understandability for cloud resource management. FIG. 4A includes a first data type indicator 402, a first configurable parameter 404, a second configurable parameter 406, and a third configurable parameter 408. The first data type indicator 402 is associated with the first configurable parameter 404. The first data type indicator 402 indicates that the first configurable parameter 404 is of type object. The first configurable parameter 404 is the corresponding input area for a user to enter an input value to configure the first configurable parameter 402. The second configurable parameter 406 is a radio button, which allows the user to choose only one of a predefined set of mutually exclusive options. The third configurable parameter 408 is a text area input.

The code management circuitry 122 allows for the association of one or more data types with input parameters (e.g., input parameters identified by metadata). In some examples, the code management circuitry 122 may specify a data type for a parameter, rendering the input field with the appropriate context and behavior.

FIG. 4B is an illustration of an example state area to improve code understandability for cloud resource management. The example state area of FIG. 4B offers an organized way to represent states through a tree structure. The hierarchical structure (e.g., tree structure) allows for simplified navigation and a clear overview of nested states. FIG. 4B includes an example of a nested state. The first state 410 is a configuration state, which is at a first level of the hierarchy. The second state 412 is an example of a state at a second level of the hierarchy. Thus, a user can select the first state 410 by clicking on the first state 410 to view the corresponding input parameters and infrastructure management code. Although the example of FIG. 4B is described in association with a hierarchical tree structure, alternate user interface design styles are also compatible with the code management circuitry 122. For example, multiple panels which include groupings, a slide menu, an accordion menu, a graph, etc., may be generated with the code management circuitry 122.

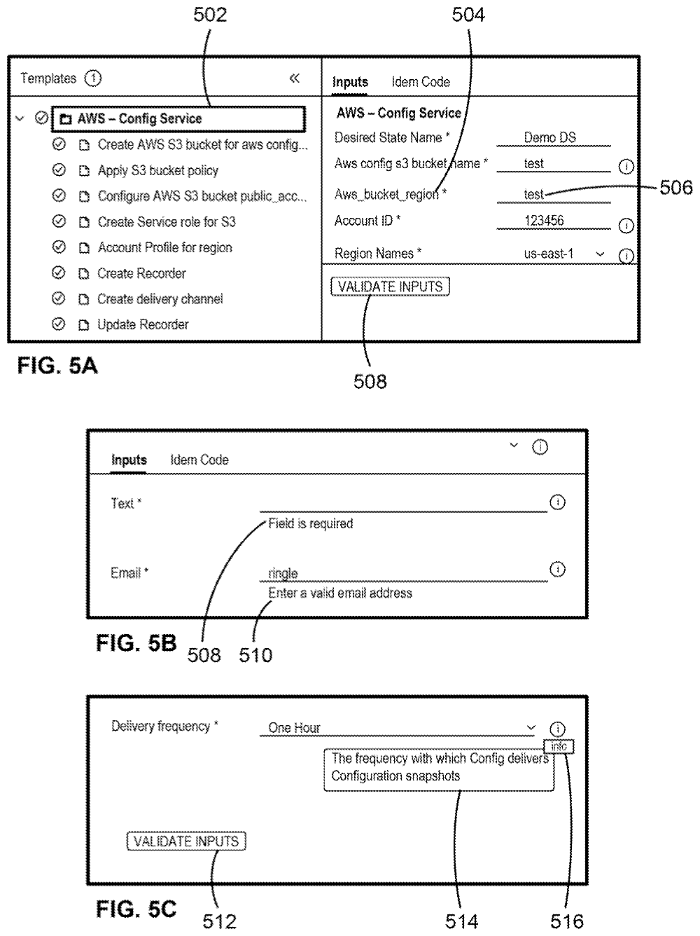

FIG. 5A is an illustration of the example user interface of FIG. 3 after an input button is selected. The illustration of FIG. 5A shows a first state 502 is selected. The first state 502 is a configuration (e.g., modification state). A first configurable parameter 504 corresponds to a first input value 506. FIG. 5A also illustrates an input validation button 508. Selecting the input validation button 508 can cause the code management circuitry 122 to validate one or more input values that have been input by a user.

FIG. 5B is an illustration of the example input area of FIG. 4A in a second state. The code management circuitry 122 or the status indicator circuitry 212 can highlight required parameters by providing status indicators, suggestions, and/or text highlighting. Thus, the status indicator circuitry 212 can allow a user to identify parameters that are required and ensure that they are entered correctly.

A first status indicator 508 illustrates how the status indicator circuitry 212 may respond to a missing input value. When a required parameter is missing, the status indicator circuitry 212 can display a message indicating which parameter is missing and/or provide suggestions for how to fix the issue.

A second status indicator 510 illustrates how the status indicator circuitry 212 may respond to a missing input value. That is, the status indicator circuitry 212 may provide the second status indicator 510 when a user has failed to enter an input value that is required by the code management circuitry 122. Furthermore, the status indicator circuitry 212 can also highlight a missing input value for a configurable parameter in the code editor section, thereby facilitating remediation of the deficiency.

Similarly, when an incorrect value is entered for a parameter, the status indicator circuitry 212 can display a message indicating the error and provide suggestions for how to correct the issue. The incorrect value can also be highlighted, making the insufficiency easier to find and correct.

FIG. 5C is an example of a tooltip and a validation button to improve code understandability for cloud resource management. The code management circuitry 122 can enhance the user experience when configuring inputs for a service with a metadata (e.g., meta) feature to provide input parameter labels. By providing custom labels and description for input parameters, users can more easily identify the purpose and function of each parameter, reducing the likelihood of errors and improving the overall user experience. By using a meta feature, users can customize the labels to match their specific needs and preferences, making input parameters more meaningful and clear.

Flowchart(s) representative of example machine readable instructions, which may be executed by programmable circuitry to implement and/or instantiate the code management circuitry 122 of FIG. 2 and/or representative of example operations which may be performed by programmable circuitry to implement and/or instantiate the code management circuitry 122 of FIG. 2, are shown in FIGS. 6-8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-8, many other methods of implementing the example code management circuitry 122 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed, instantiated, and/or performed by programmable circuitry to improve code understandability. The example machine-readable instructions and/or the example operations 600 of FIG. 6 begin at block 602, at which the example data parsing circuitry 204 identifies a file format of a file. At block 604, the example input parameter management circuitry 206 obtains configurable parameters based on a parse of the file. Then, at block 606, the example input parameter management circuitry 206 obtains a first input value corresponding to a first configurable parameter of the configurable parameters, the first configurable parameter value associated with a first state of a plurality of states. At block 608, the example user interface circuitry 202, responsive to interaction with an area of the user interface associated with the first configurable parameter value, displays status information associated with the first input value.

At block 610, the state management circuitry 208, responsive to interaction with an area of the user interface associated with a second state of the plurality of states, displays a second configurable parameter associated with a second state of the plurality of states. At block 612, the example input parameter management circuitry 206 obtains a second input value corresponding to a second configurable parameter, the second configurable parameter associated with the second state.

FIG. 7A is a flowchart representative of example machine readable instructions and/or example operations 700 that may be executed, instantiated, and/or performed by programmable circuitry to implement the code management circuitry 122 of FIG. 1. The instructions 700 begin at block 702, at which the data parsing circuitry 204 identifies configurable parameters in an infrastructure configuration file, the configurable parameters to define states of a cloud resource. At block 704, the example state management circuitry 208 maps a first configurable parameter of the configurable parameters to a first state of the states based on first metadata parsed form the infrastructure configuration file.

At block 706, the example user interface circuitry 202 and/or the state management circuitry 208 displays the first state in a graphical user interface including a hierarchy of states, wherein selection of a second state of the plurality of states from the hierarchy displays a second configurable parameter associated with the second state. At block 708, the example input parameter management circuitry 206 prevents a misconfiguration of the cloud resource based on an application of a validation constraint to an input value for the second configurable parameter, the validation constraint generated based on second metadata parsed from the infrastructure configuration file.

FIG. 7B is a flowchart representative of example machine readable instructions and/or example operations 710 that may be executed, instantiated, and/or performed by programmable circuitry to display configurable parameters associated with states. The instructions 710 begin at block 712, at which the user interface circuitry 202 displays a first file in a first area of the user interface. At block 714, the example data parsing circuitry 204 parses the first file for first and second user-configurable parameters. At block 716, the example input parameter management circuitry 206 displays the first user configurable parameter in the user interface, the first user-configurable parameter associated with a first state of the resource. At block 718, the example input parameter management circuitry 206 obtains a user provided parameter value for the first user configurable parameter of the user configurable parameters. At block 720, the example user interface circuitry 202 identifies an interaction with a second area of the user interface, the second area associated with a second state of the resource. At block 722, the example user interface circuitry 202 displays the second user configurable parameter in the user interface, the second user-configurable parameter associated with the second state of the resource.

FIG. 8 is a flowchart representative of example machine readable instructions and/or example operations 800 that may be executed, instantiated, and/or performed by programmable circuitry to display configurable parameters associated with states. At block 802, the example input parameter management circuitry 206 identifies a missing configurable parameter. At block 804, the example status indicator circuitry 212 highlights text associated with the missing configurable parameter. At block 806, the example status indicator circuitry 212 generates a text recommendation to provide a value for the configurable parameter.

At block 808, the example input parameter management circuitry 206 determine a first value provided for the configurable parameter is invalid. At block 810, the example status indicator circuitry 212 highlights the invalid first value. At block 812, the example status indicator circuitry 212 provides an indication to correct the invalid first value. At block 814, the example input parameter management circuitry 206 determine a second value associated with the configurable parameter is valid.

FIG. 9 is a block diagram of an example programmable circuitry platform 900 structured to execute and/or instantiate the example machine-readable instructions and/or the example operations of FIGS. 6-8 to implement the code management circuitry 122 of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements user interface circuitry 202, data parsing circuitry 204, input parameter management circuitry 206, state management circuitry 208, code editor circuitry 210, and status indicator circuitry 212.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 6-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 6-8 to effectively instantiate the circuitry of FIG. 2 as logic circuits to perform operations corresponding to those machine readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 6-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 6-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-8. As such, the FPGA circuitry 1100 may be configured and/or structured to effectively instantiate some or all of the operations/functions corresponding to the machine readable instructions of the flowchart(s) of FIGS. 6-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 6-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 6-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 6-8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIG. 6-8, and/or an ASIC may be configured and/or structured to perform third operation(s)/function(s) corresponding to a third portion of the machine readable instructions represented by the flowcharts of FIGS. 6-8.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

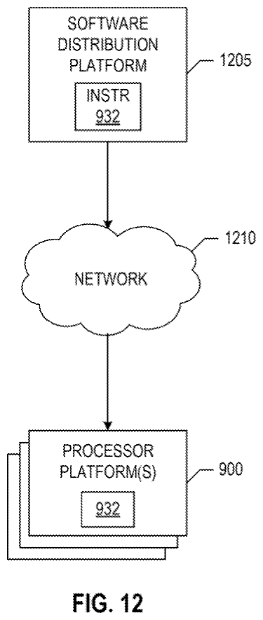

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 6-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIG. 6-8, may be downloaded to the example programmable circuitry platform 900, which is to execute the machine readable instructions 932 to implement the code management circuitry 122. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that improve code understandability for cloud resource management. Disclosed systems, apparatus, articles of manufacture, and methods improve the efficiency of using a computing device by reducing deployment errors. States are represented in a tree structure which displays nested states, input parameters, and IDEM code responsive to a user click. Furthermore, disclosed examples provide an improved user interface to improve cloud infrastructure deployment by providing proper parameter validation, a clear representation of states and parameters, and pre-deployment checks. Examples disclosed herein significantly simplify the deployment and management of infrastructure as code. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to improve code understandability for cloud resource management are disclosed herein. Further examples and combinations thereof include the following:

Example 1 includes an apparatus comprising at least one memory, programmable circuitry, and instructions to cause the programmable circuitry to identify configurable parameters in an infrastructure configuration file, the configurable parameters to define states of a cloud resource, map a first configurable parameter of the configurable parameters to a first state of the states based on first metadata parsed from the infrastructure configuration file, the first state displayed in a graphical user interface including a hierarchy of states, wherein selection of a second state of the states from the hierarchy displays a second configurable parameter associated with the second state, and prevent a misconfiguration of the cloud resource based on an application of a validation constraint to an input value for the second configurable parameter, the validation constraint generated based on second metadata parsed from the infrastructure configuration file.

Example 2 includes the apparatus of example 1, wherein the programmable circuitry is to, responsive to interaction with an area of the graphical user interface associated with the first configurable parameter, display status information associated with the first configurable parameter.

Example 3 includes the apparatus of example 2, wherein the status information includes an indication that the input value is invalid.

Example 4 includes the apparatus of example 2, wherein the status information includes an indication that the input value is missing.

Example 5 includes the apparatus of example 1, wherein the graphical user interface includes a states area, an input parameter area, and a code editor area.

Example 6 includes the apparatus of example 1, wherein the states include a provisioning state to provision the cloud resource, a scaling state to scale the cloud resource, and a modification state to modify the cloud resource.

Example 7 includes the apparatus of example 1, wherein the infrastructure configuration file is a text encoded file and the configurable parameters include security settings, performance settings, and cost settings of the cloud resource.

Example 8 includes a non-transitory computer readable storage medium comprising instructions, which when executed by programmable circuitry, cause the programmable circuitry to identify configurable parameters in an infrastructure configuration file, the configurable parameters to define states of a cloud resource, map a first configurable parameter of the configurable parameters to a first state of the states based on first metadata parsed from the infrastructure configuration file, the first state displayed in a graphical user interface including a hierarchy of states, wherein selection of a second state of the states from the hierarchy displays a second configurable parameter associated with the second state, and prevent a misconfiguration of the cloud resource based on an application of a validation constraint to an input value for the second configurable parameter, the validation constraint generated based on second metadata parsed from the infrastructure configuration file.

Example 9 includes the non-transitory computer readable storage medium of example 8, wherein the programmable circuitry is to, responsive to interaction with an area of the graphical user interface associated with the first configurable parameter, display status information associated with the first configurable parameter.

Example 10 includes the non-transitory computer readable storage medium of example 9, wherein the status information includes an indication that the input value is invalid.

Example 11 includes the non-transitory computer readable storage medium of example 9, wherein the status information includes an indication that the input value is missing.

Example 12 includes the non-transitory computer readable storage medium of example 8, wherein the graphical user interface includes a states area, an input parameter area, and a code editor area.

Example 13 includes the non-transitory computer readable storage medium of example 8, wherein the states include a provisioning state to provision the cloud resource, a scaling state to scale the cloud resource, and a modification state to modify the cloud resource.

Example 14 includes the non-transitory computer readable storage medium of example 8, wherein the infrastructure configuration file is a text encoded file and the configurable parameters include security settings, performance settings, and cost settings of the cloud resource.

Example 15 includes a method comprising identifying, by executing an instruction with programmable circuitry, configurable parameters in an infrastructure configuration file, the configurable parameters to define states of a cloud resource, mapping, by executing an instruction with the programmable circuitry, a first configurable parameter of the configurable parameters to a first state of the states based on first metadata parsed from the infrastructure configuration file, the first state displayed in a graphical user interface including a hierarchy of states, wherein selection of a second state of the states from the hierarchy displays a second configurable parameter associated with the second state, and preventing, by executing an instruction with the programmable circuitry, a misconfiguration of the cloud resource based on an application of a validation constraint to an input value for the second configurable parameter, the validation constraint generated based on second metadata parsed from the infrastructure configuration file.

Example 16 includes the method of example 15, further including, responsive to interaction with an area of the graphical user interface associated with the first configurable parameter, displaying status information associated with the first configurable parameter.

Example 17 includes the method of example 16, wherein the status information includes an indication that the input value is invalid.

Example 18 includes the method of example 16, wherein the status information includes an indication that the input value is missing.

Example 19 includes the method of example 15, wherein the graphical user interface includes a states area, an input parameter area, and a code editor area.

Example 20 includes the method of example 15, wherein the states include a provisioning state to provision the cloud resource, a scaling state to scale the cloud resource, and a modification state to modify the cloud resource.

Example 21 includes the method of example 15, wherein the infrastructure configuration file is a text encoded file and the configurable parameters include security settings, performance settings, and cost settings of the cloud resource.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
at least one memory;
programmable circuitry; and
instructions to cause the programmable circuitry to:
identify configurable parameters in an infrastructure configuration file, the configurable parameters to define states of a cloud resource;
map a first configurable parameter of the configurable parameters to a first state of the states based on first metadata parsed from the infrastructure configuration file, the first state displayed in a graphical user interface including a hierarchy of states, wherein selection of a second state of the states from the hierarchy displays a second configurable parameter associated with the second state; and
prevent a misconfiguration of the cloud resource based on an application of a validation constraint to an input value for the second configurable parameter, the validation constraint generated based on second metadata parsed from the infrastructure configuration file.

2. The apparatus of claim 1, wherein the programmable circuitry is to, responsive to interaction with an area of the graphical user interface associated with the first configurable parameter, display status information associated with the first configurable parameter.

3. The apparatus of claim 2, wherein the status information includes an indication that the input value is invalid.

4. The apparatus of claim 2, wherein the status information includes an indication that the input value is missing.

5. The apparatus of claim 1, wherein the graphical user interface includes a states area, an input parameter area, and a code editor area.

6. The apparatus of claim 1, wherein the states include a provisioning state to provision the cloud resource, a scaling state to scale the cloud resource, and a modification state to modify the cloud resource.

7. The apparatus of claim 1, wherein the infrastructure configuration file is a text encoded file and the configurable parameters include security settings, performance settings, and cost settings of the cloud resource.

8. A non-transitory computer readable storage medium comprising instructions, which when executed by programmable circuitry, cause the programmable circuitry to:
identify configurable parameters in an infrastructure configuration file, the configurable parameters to define states of a cloud resource;
map a first configurable parameter of the configurable parameters to a first state of the states based on first metadata parsed from the infrastructure configuration file, the first state displayed in a graphical user interface including a hierarchy of states, wherein selection of a second state of the states from the hierarchy displays a second configurable parameter associated with the second state; and
prevent a misconfiguration of the cloud resource based on an application of a validation constraint to an input value for the second configurable parameter, the validation constraint generated based on second metadata parsed from the infrastructure configuration file.

9. The non-transitory computer readable storage medium of claim 8, wherein the programmable circuitry is to, responsive to interaction with an area of the graphical user interface associated with the first configurable parameter, display status information associated with the first configurable parameter.

10. The non-transitory computer readable storage medium of claim 9, wherein the status information includes an indication that the input value is invalid.

11. The non-transitory computer readable storage medium of claim 9, wherein the status information includes an indication that the input value is missing.

12. The non-transitory computer readable storage medium of claim 8, wherein the graphical user interface includes a states area, an input parameter area, and a code editor area.

13. The non-transitory computer readable storage medium of claim 8, wherein the states include a provisioning state to provision the cloud resource, a scaling state to scale the cloud resource, and a modification state to modify the cloud resource.

14. The non-transitory computer readable storage medium of claim 8, wherein the infrastructure configuration file is a text encoded file and the configurable parameters include security settings, performance settings, and cost settings of the cloud resource.

15. A method comprising:
identifying, by executing an instruction with programmable circuitry, configurable parameters in an infrastructure configuration file, the configurable parameters to define states of a cloud resource;
mapping, by executing an instruction with the programmable circuitry, a first configurable parameter of the configurable parameters to a first state of the states based on first metadata parsed from the infrastructure configuration file, the first state displayed in a graphical user interface including a hierarchy of states, wherein selection of a second state of the states from the hierarchy displays a second configurable parameter associated with the second state; and
preventing, by executing an instruction with the programmable circuitry, a misconfiguration of the cloud resource based on an application of a validation constraint to an input value for the second configurable parameter, the validation constraint generated based on second metadata parsed from the infrastructure configuration file.

16. The method of claim 15, further including, responsive to interaction with an area of the graphical user interface associated with the first configurable parameter, displaying status information associated with the first configurable parameter.

17. The method of claim 16, wherein the status information includes an indication that the input value is invalid.

18. The method of claim 16, wherein the status information includes an indication that the input value is missing.

19. The method of claim 15, wherein the graphical user interface includes a states area, an input parameter area, and a code editor area.

20. The method of claim 15, wherein the states include a provisioning state to provision the cloud resource, a scaling state to scale the cloud resource, and a modification state to modify the cloud resource.

21. The method of claim 15, wherein the infrastructure configuration file is a text encoded file and the configurable parameters include security settings, performance settings, and cost settings of the cloud resource.
